(19) United States
(12) Patent Application Publication
(10) Pub. No.: US 2011/0191159 A1
(43) Pub. Date: Aug. 4, 2011

(54) SAVINGS AND REWARDS PROGRAM

(76) Inventors: Lynn HEITMAN, Milwaukee, WI (US); Ryan Gage, Minneapolis, MN (US); Trent Spurgeon, St. Paul, MN (US)

(21) Appl. No.: 12/698,536

(22) Filed: Feb. 2, 2010

(51) Int. Cl. G06Q 30/00; G06Q 40/00

(52) U.S. Cl. 705/14.35

(57) ABSTRACT

A method for providing a savings and rewards program includes receiving a selection of one or more transfer options for making automated funds transfers from a transferor account to a transferee account. A first amount of funds is transferred from the transferor account to the transferee account based on the selection. A determination is made, based at least in part on a comparison of a transferee account balance to a first threshold balance, regarding whether the customer is eligible for a first reward. The first reward is provided to a customer if it is determined that the customer is eligible. A determination is made regarding whether the customer has maintained a second threshold balance in the transferee account for a predetermined time period. The customer is provided with a second reward if it is determined that the customer has maintained the second threshold balance for the predetermined time period.

### BACKGROUND

Saving money is an important goal of many individuals. Stockpiling cash, investing in stocks, bonds, real estate, etc., contributing to a 401(k) account, contributing to an education fund for a child, and establishing savings accounts are all methods by which individuals attempt to save and invest their money. Some forms of saving and investing, such as purchasing stocks, carry a higher risk than other forms of saving and investing. For example, establishing an Federal Deposit Insurance Corporation (FDIC) insured savings account is relatively low risk. A traditional savings account offered by a financial institution provides the account holder a secure location to store funds and pays interest on the stored funds. However, interest rates are often low and may not provide a significant incentive for individuals to establish a savings account.

### SUMMARY

An illustrative method for providing a savings and rewards program is provided. The method includes receiving a selection of one or more transfer options for making automated funds transfers from a transferor account of a customer to a transferee account of the customer. A first amount of funds is transferred from the transferor account to the transferee account based at least in part on the selection of the one or more transfer options. A determination is made, based at least in part on a comparison of a balance of the transferee account to a first threshold balance, regarding whether the customer is eligible for a first reward. The determining is performed at least in part by a financial institution computing system. The first reward is provided to the customer if it is determined that the customer is eligible for the first reward. A determination is made regarding whether the customer has maintained a second threshold balance in the transferee account for a predetermined time period. The customer is provided with a second reward if it is determined that the customer has maintained the second threshold balance in the transferee account for the predetermined time period.

An illustrative financial institution computing system is also provided. The computing system includes a transceiver and a processor operatively coupled to the transceiver. The transceiver is configured to receive a selection of one or more transfer options for making automated funds transfers from a transferor account of a customer to a transferee account of the customer. The processor is configured to transfer a first amount of funds from the transferor account to the transferee account based at least in part on the selection of the one or more transfer options. The processor is also configured to determine, based at least in part on a comparison of a balance of the transferee account to a first threshold balance, whether the customer is eligible for a first reward. The processor is further configured to determine whether the customer is eligible for a second reward based on whether the customer has maintained a second threshold balance in the transferee account for a predetermined time period.

An illustrative computer-readable medium is also provided. The computer-readable medium has computer-readable instructions stored thereon. Upon execution by a computing device, the computer-readable instructions cause the computing device to receive a selection of one or more transfer options for making automated funds transfers from a transferor account of a customer to a transferee account of the customer. The computer-readable instructions also cause the computing device to transfer a first amount of funds from the transferor account to the transferee account based at least in part on the selection of the one or more transfer options. The computer-readable instructions also cause the computing device to determine, based at least in part on a comparison of a balance of the transferee account to a first threshold balance, whether the customer is eligible for a first reward. The computer-readable instructions further cause the computing device to determine whether the customer is eligible for a second reward based on whether the customer has maintained a second threshold balance in the transferee account for a predetermined time period.

Other principal features and advantages will become apparent to those skilled in the art upon review of the following drawings, the detailed description, and the appended claims.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a flow diagram illustrating operations for enrolling a customer in a savings and rewards program and transferring funds in accordance with an illustrative embodiment.

FIG. 2 is a flow diagram illustrating operations for providing rewards to a customer in accordance with an illustrative embodiment.

FIG. 3 is a block diagram illustrating a system for implementing the savings and rewards program in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

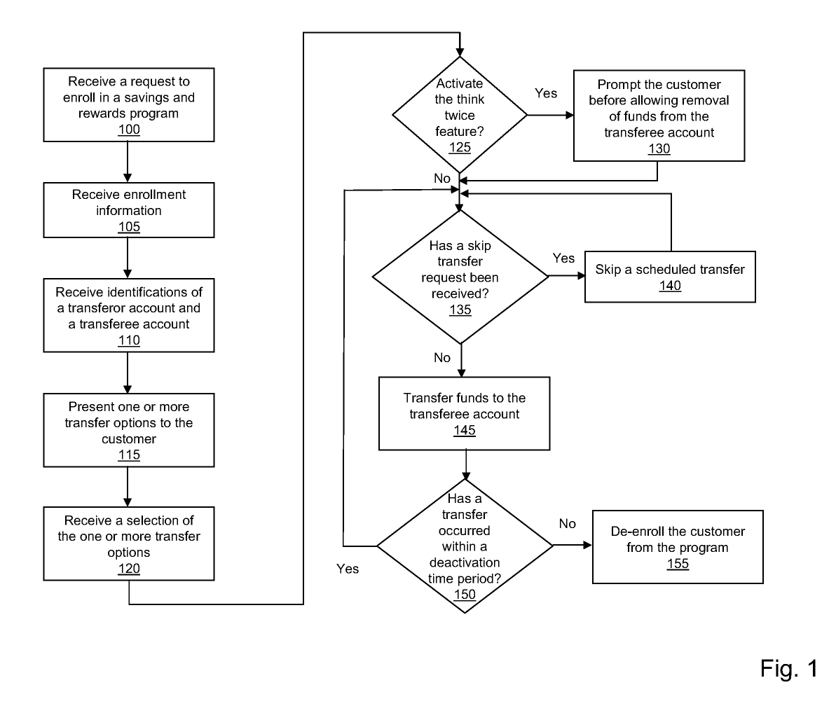

The inventors have perceived the need for a savings and rewards program that provides goals based incentives to customers of a financial institution. As such, described herein are illustrative systems and methods for a savings and rewards program. FIG. 1 is a flow diagram illustrating operations for enrolling a customer in a savings and rewards program and transferring funds in accordance with an illustrative embodiment. In alternative embodiments, fewer, additional, and/or different operations may be performed. The operations described with reference to FIG. 1 can be performed by a financial institution such as a bank, credit union, etc. that is offering the savings and rewards program to its customers. In an illustrative embodiment, the operations of FIG. 1 are performed by an automated system of the financial institution. Alternatively, one or more of the operations may be performed manually by employees of the financial institution.

In an operation 100, a request to enroll in the savings and rewards program is received from a customer. The customer can be a new customer or an existing customer of the financial institution. The request can be received by way of a data network such as the Internet, a telecommunications network, an automated teller machine (ATM), or in person at a branch location of the financial institution. Other information, requests, and selections received from the customer can similarly be received through any of the above-referenced channels. In an operation 105, enrollment information is received from the customer. The enrollment information can include a name of the customer, a residential address of the customer, an e-mail address of the customer, a telephone number of the customer, a social security or tax identification number of the customer, and/or other personal information of the customer.

In an operation 110, identifications of a transferor account and a transferee account are received. In an illustrative embodiment, the transferor account is a checking account and the transferee account is a savings account such as a traditional savings account, a money market savings account, etc. Alternatively, the transferor account may also be a savings account, a credit/debit card rewards account, etc. The identifications of the accounts can include account numbers, routing numbers associated with the accounts, names associated with the accounts, and/or other account information. If the customer does not have existing accounts that are to be designated as the transferor/transferee accounts, the customer can establish one or more new accounts instead of providing the identifications of existing accounts. The customer can designate more than one transferor account and/or more than one transferee account to be used in the savings and rewards program.

In an operation 115, one or more transfer options are presented to the customer. The one or more transfer options are one or more designated actions or transactions that result in a transfer of funds from the transferor account of the customer to the transferee account of the customer. One illustrative transfer option is to automatically transfer a predetermined amount of funds from the transferor account to the transferee account each time the customer uses his/her debit card to conduct a transaction. The predetermined amount of funds may be established by the customer or set by the financial institution, depending on the embodiment. In one embodiment, the financial institution provides the customer with a range of fund amounts that can be transferred and the customer selects the amount within the range. Illustrative ranges of fund amounts can be any amount between $0.25 and $5.00, any amount between $0.50 and $10.00, any amount between $1.00 and $25.00, etc. The debit card transaction can include a purchase and/or a withdrawal of funds. In an illustrative embodiment, the debit card is associated with the transferor account such that debit card transactions utilize funds from the transferor account. Alternatively, the debit card may be associated with the transferee account or another account that is neither the transferor account nor the transferee account.

Another illustrative transfer option is to automatically transfer a predetermined amount of funds from the transferor account to the transferee account each time the customer uses his/her credit card. The predetermined amount of funds may be established by the customer or set by the financial institution, depending on the embodiment. In one embodiment, the financial institution provides the customer with a range of fund amounts that can be transferred and the customer selects the amount within the range. Illustrative ranges of fund amounts can be any amount between $0.25 and $5.00, any amount between $0.50 and $10.00, any amount between $1.00 and $25.00, etc. The credit card transaction can include a purchase and/or a cash advance.

Another illustrative transfer option is to automatically transfer a predetermined amount of funds from the transferor account to the transferee account on a recurring basis. The predetermined amount of funds may be established by the customer or set by the financial institution, depending on the embodiment. In one embodiment, the financial institution provides the customer with a range of fund amounts that can be transferred and the customer selects the amount within the range. Illustrative ranges of fund amounts can be any amount between $1.00 and $10.00, any amount between $5.00 and $10.00, any amount between $5.00 and $50.00, any amount between $10.00 and $100.00, etc. The funds transfer can be scheduled to occur daily, weekly, bi-weekly, monthly, etc. The customer may also designate a specific date or dates on which the funds transfer is to occur such as on the 15^{th} of each month, on each payday of the customer, etc.

Another illustrative transfer option is to automatically transfer rewards (or bonuses) earned by the customer for using his/her debit card or credit card into the transferee account. In such an embodiment, the credit/debit card rewards account is a transferor account of the customer. One or more additional transferor accounts, such as a checking account, may also be used by the customer to transfer funds to the transferee account (i.e., in addition to the credit/debit card rewards account). The rewards can be earned through any established cash back program, miles program, etc. that is associated with a credit/debit card of the user. The rewards can be transferred according to a schedule that is set by the financial institution or by the customer, depending on the embodiment. For example, the financial institution may automatically transfer the rewards into the transferee account on the 15^{th} of each month. In an illustrative embodiment, the rewards are transferred regardless of any minimum rewards balance usage requirements of the corresponding credit/debit card. For example, the card may have a policy that the customer can only utilize his/her rewards in the rewards account when the rewards account balance is at least $50.00. With the savings and rewards program, the rewards account balance can be transferred to the transferee account once a week, once a month, etc., regardless of whether the rewards account balance is $2.00, $25.00, or $100.00.

In an operation 120, a selection of at least one of the one or more transfer options is received from the customer. In an illustrative embodiment, the customer can select more than one transfer option. If the customer selects the debit card transfer option or the credit card transfer option, the customer can provide the card number, the card expiration date, the card security code, the name(s) on the card, the account number of the account associated with the debit card, etc. In one embodiment, the customer may designate more than one debit card and/or more than one credit card. The customer can also specify the amount of funds that are to be transferred as a result of transactions conducted with each of the credit/debit cards. The amount of funds transferred may be different for each of the credit and/or debit cards that the customer designates to be used in the savings and rewards program. In one embodiment, the customer may only be able to designate credit/debit cards that are provided to the customer through the financial institution. As such, the customer may request and receive a new debit card and/or a new credit card as part of the enrollment into the savings and rewards program.

If the customer selects the recurring transfer option, the customer can designate the amount of funds that are to be transferred from the transferor account to the transferee account on a recurring basis. The customer can also designate the frequency with which the transfers are to occur and/or the day(s) on which the transfers are to occur. If the customer selects the credit/debit card rewards transfer option, the customer can provide the card number, card expiration date, name(s) on the card, and an identification of the rewards or bonus program in which the card is enrolled. In an illustrative embodiment, the customer can designate more than one card and/or more than one rewards program balance that is to be transferred to the transferee account.

In an operation 125, an indication of whether the customer desires to activate a think twice feature is received. The think twice feature of the savings and rewards program presents the customer with a message or prompt that allows the customer to reconsider any transaction that would remove funds from the transferee account. The transaction that would remove funds from the transferee account may be a withdrawal, a transfer of funds from the transferee account to another account, a debit to the transferee account, a bill pay taken from the transferee account, etc. The message can be provided through any channel by which the customer is able to perform a transaction involving the transferee account. For example, the message may be presented to the customer by an employee of the financial institution if the customer attempts to withdraw funds from the transferee account at a branch location. The message may also be presented to the customer as a written message at an ATM, as an audio message through a telephone banking system, as a written message through an Internet or network banking system, etc.

An illustrative think twice message can be: “The account from which you are attempting to withdraw funds is enrolled in the Savings and Rewards Program. The withdrawal of funds may affect your ability to receive rewards for this account. Please confirm that you would like to proceed with the withdrawal.” The think twice message may also indicate specifically how the proposed withdrawal will affect rewards for the account. For example, the think twice message may state that “The proposed withdrawal of funds will bring your account balance below a reward threshold set for this account and may affect your ability to receive the reward.” Other messages may also be used. If the think twice feature is activated, the customer is prompted with a think twice message if the customer requests a removal of funds from the transferee account in an operation 130. The think twice message can allow the customer to specify whether or not he/she wishes to proceed with the transaction.

Regardless of whether the think twice function is activated, in an operation 135 a determination of whether the customer has requested that a transfer be skipped is made prior to transferring funds from the transferor account to the transferee account. The skip transfer request can be made by the customer in person at a branch location of the financial institution, through an ATM, through a telephone banking system, through an Internet or network banking system, etc. If the customer has selected more than one transfer option, the skip transfer request can apply to multiple transfers. In an illustrative embodiment, the customer may request that the transfer(s) be skipped such that the balance of the transferor account is sufficient to pay bills, so that the balance does not drop below a minimum balance, etc. As an example, the transferor account may have a balance of $225 and the customer may be aware of an upcoming bill of $200 that is going to be paid with funds from the transferor account. To ensure that the transferor account has enough funds to pay the upcoming bill, the customer may place a skip transfer request on an upcoming recurring transfer of $40 from the transferor account to the transferee account.

In an illustrative embodiment, a scheduled transfer can automatically be skipped (i.e., regardless of whether a skip transfer request is received) if the scheduled transfer would result in a negative balance in the transferor account or a balance that is below a minimum balance of the transferor account. In one embodiment, a determination can also be made regarding whether a pending transaction associated with the transferor account in combination with the scheduled transfer would result in a negative balance or a balance below the minimum balance of the transferor account. For example, during enrollment, the customer may have indicated that an amount of $5.00 is to be transferred from the transferor account to the transferee account for each debit card transaction involving a debit card that is associated with the transferor account. If the account balance of the transferor account is $25.00 and a debit card transaction is $22, the $5.00 scheduled transfer from the transferor account may be automatically canceled so that the transferor account balance does not go below zero.

If a skip transfer request is received from the customer, one or more scheduled transfers are skipped in an operation 140. Subsequent scheduled transfers from the transferor account to the transferee account will be carried out unless subsequent skip transfer requests are received from the customer. If a skip transfer request is not received from the customer, a transfer of funds from the transferor account to the transferee account occurs in an operation 145. In an illustrative embodiment, the transferee account also receives interest from the financial institution by any method known to those of skill in the art.

In an operation 150, a determination is made regarding whether a transfer from the transferor account to the transferee account has occurred with a deactivation time period. The deactivation time period can be 3 months, 6 months, or other period of time established by the financial institution. In an illustrative embodiment, the determination of operation 150 is with respect to a transfer that has been scheduled and made in accordance with the savings and rewards program. As such, a transfer by the customer of funds from the transferor account to the transferee account outside of the savings and rewards program may not be considered an eligible transfer in operation 150. Alternatively, a transfer made by the customer outside of the savings and rewards program may satisfy the determination in operation 150. If a transfer has occurred within the deactivation time period, the customer remains enrolled in the savings and rewards program and subsequent transfers are scheduled unless a skip transfer request is received. If a transfer has not occurred within the deactivation time period, the customer is de-enrolled from the savings and rewards program in an operation 155.

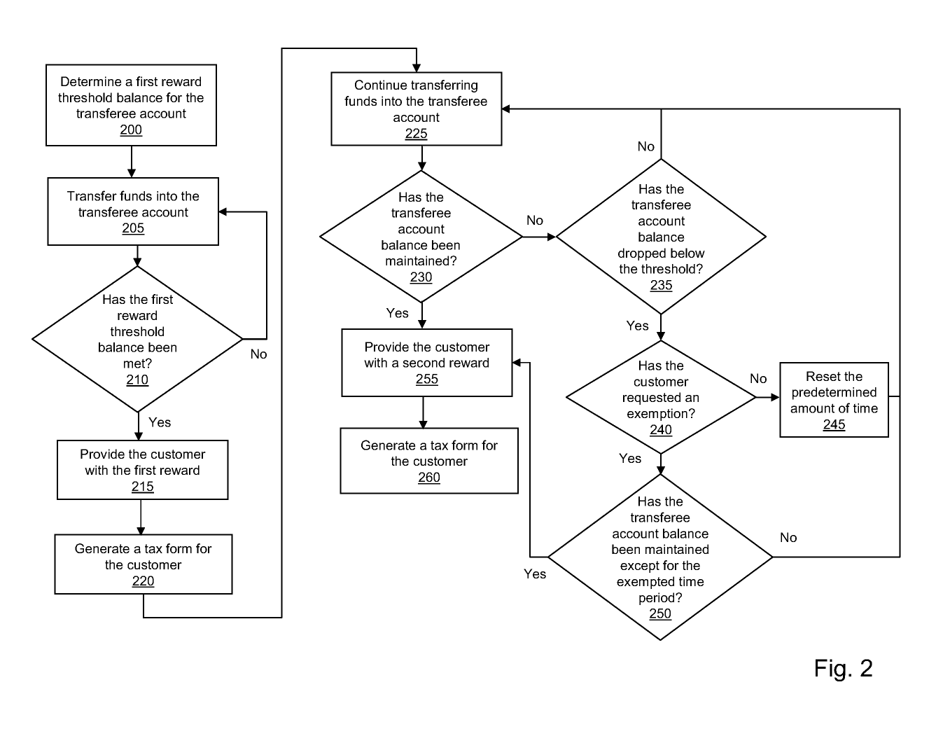

FIG. 2 is a flow diagram illustrating operations for providing rewards to a customer in accordance with an illustrative embodiment. In alternative embodiments, fewer, additional, and/or different operations may be performed. In an operation 200, a first reward threshold balance for the transferee account is determined. When the balance of the transferee account is equal to or in excess of the first reward threshold balance, the customer is provided with a first reward. In an illustrative embodiment, the first reward threshold balance that results in the first reward is $1000. Alternatively, the first reward threshold balance that results in the first reward may be $500, $1500, $2000, etc.

In one embodiment, the first reward threshold balance that results in the first reward is based on whether the transferee account is a new account or an existing account. If the transferee account is a new account (i.e., the transferee account is established at the time that the customer enrolls in the savings and rewards program), any initial deposit into the new account can count towards the first reward threshold balance. As an example, if the first reward threshold balance is $1000 and the customer deposits $600 into a new account that is designated as the transferee account, only $400 needs to be transferred into the new account to make the customer eligible for the first reward. If the transferee account is an existing account (i.e., the transferee account exists prior to the time when the customer enrolls in the savings and rewards program), an existing balance in the existing account does not count towards the first reward threshold balance. For example, if the first reward threshold balance is $1000 and the existing account has an existing balance of $600 at the time the customer enrolls in the savings and rewards program, the customer has to attain a balance of $1600 in the transferee account in order to be eligible for the first reward. In an alternative embodiment, an initial balance in the transferee account may not count toward the first reward threshold balance regardless of whether the transferee account is a new account or an existing account. In another alternative embodiment, an initial balance in the transferee account may count toward the first reward threshold balance regardless of whether the transferee account is a new account or an existing account.

In an operation 205, funds are transferred into the transferee account from the transferor account as described with reference to FIG. 1. The funds can be transferred as a result of one or more transfer options selected by the customer. For example, the transfer of funds can be a predetermined amount for each debit card transaction of the customer, a predetermined amount for each credit card transaction of the customer, a recurring amount set by the customer, and/or rewards earned from use of a credit card or debit card. Interest can also be credited to the transferee account by the financial institution.

In an operation 210, a determination is made regarding whether the first reward threshold balance has been met. The determination is based on a comparison of an account balance of the transferee account to the first reward threshold balance as determined in operation 200. As indicated above, the first reward threshold balance may be based at least in part on whether the transferee account was an existing account at the time the customer enrolled into the savings and rewards program or a new account established at the time of enrollment into the savings and rewards program. If the first reward threshold balance has not been met, funds continue to be transferred into the transferee account in operation 205 until the first reward threshold balance is met.

If the first reward threshold balance is met, the customer is provided with a first reward in an operation 215. In an illustrative embodiment, the first reward is a monetary reward that is provided to the customer in the form of cash, a check, a pre-paid debit card, etc. The monetary reward can be provided to the customer in person or through the mail. Alternatively, the monetary reward may be automatically credited to the transferee account or a different financial account of the customer. In one embodiment, the monetary reward is $50. Alternatively, other values may be used such as $25, $75, $100, etc. In another alternative embodiment, the first reward may be in the form of free or discounted travel, free or discounted accommodations, free or discounted merchandise, etc. In one embodiment, the customer is provided with the first reward only if a scheduled transfer associated with the program has occurred with a predetermined number of days preceding the date on which the first reward threshold balance is met. For example, the first reward may be awarded only if a program-related transfer occurred within the last thirty-five days preceding the date on which the first reward threshold balance is attained in the transferee account.

In an operation 220, a tax form is generated for the customer. In an illustrative embodiment, the tax form is a 1099-INT form that identifies the first reward as income to the customer. The customer can use the tax form to help determine his/her taxes for the year. In an operation 225, funds continue to be transferred into the transferee account in accordance with the transfer options designated by the customer. In an operation 230, a determination is made regarding whether the first reward threshold balance has been maintained in the transferee account for a predetermined amount of time. A starting date of the predetermined amount of time is the date on which the first reward threshold balance is attained in the transferee account. Alternatively, the starting date may be a different date such as the date on which the customer is provided with the first reward or the date on which the transferee account attains a second reward threshold balance.

In an illustrative embodiment, the predetermined amount of time is a year. Alternatively, the predetermined amount of time may be six months, nine months, eighteen months, two years, etc. In another illustrative embodiment, the customer is eligible for a second reward if the balance of the transferee account is equal to or in excess of the first reward threshold balance for a number of consecutive months that is equal to the predetermined amount of time. For example, if the predetermined amount of time is one year, the customer is eligible for the second reward if he/she maintains at least the first reward threshold balance in the transferee account for twelve consecutive months. In an alternative embodiment, the customer may have to maintain a second reward threshold balance in the transferee account in order to be eligible for the second reward. The second reward threshold balance can be greater than or less than the first reward threshold balance, depending on the embodiment. As an example, the first reward threshold balance may be $1000 and the second reward threshold balance may be $1500. As such, the customer may have to attain and maintain (for the predetermined amount of time) a balance of at least $1500 in the transferee account in order to be eligible for the second reward.

In one embodiment, the determination in operation 230 is based on a balance of the transferee account as taken on a particular day of each month. For example, the account balance may taken on the 1^{st} (or 15^{th}, or 20^{th}, etc.) day of each month for determining whether the first reward (or second reward) threshold balance is being maintained in the transferee account. As such, the customer is not penalized (i.e., the predetermined time period is not reset) if the account balance drops below the threshold balance as long as the account balance is equal to or in excess of the threshold balance as of the first (or other) day of the month on which the determination is made. Alternatively, the predetermined time period may be reset if the account balance drops below the threshold balance at any time.

If the transferee account balance has not been maintained at or in excess of the threshold balance for the predetermined amount of time, a determination is made regarding whether the transferee account threshold has dropped below the threshold in an operation 235. If the transferee account balance has not dropped below the threshold balance, funds continue to be transferred into the transferee account in operation 225 and the predetermined amount of time is not reset (i.e., does not start over). If the transferee account balance has dropped below the threshold, a determination is made regarding whether the customer has requested an exemption in an operation 240.

In an illustrative embodiment, an exemption is a free pass that allows the balance of the transferee account to drop below the threshold balance for an amount of time without a penalty to the customer. In another illustrative embodiment, the exemption is a one time option for the customer and can only be used if the transferee account balance remains below the threshold balance for less than a predetermined exemption time period. The predetermined exemption time period can be one month, two months, three months, etc. If the transferee account balance remains below the threshold balance for more than the predetermined exemption time period, the predetermined amount of time which the transferee account balance has to remain at the threshold balance is reset regardless of whether the customer uses the exemption. As an example, if the predetermined exemption time period is two months, the customer can use the exemption if the transferee account balance drops below the threshold balance for no longer than two months. The customer may also have a time limit during which he/she can use the exemption. For example, the customer may have to use the exemption within two months of the transferee account balance first dropping below the threshold balance. If the transferee account balance drops below the threshold balance and the customer does not use the exemption (or fails to use the exemption within the time limit), the predetermined time period is reset in an operation 245 and the process continues.

If the customer uses the exemption, a determination is made regarding whether the transferee account balance has been maintained at the threshold balance for the predetermined amount of time except for the exempted time period in an operation 250. If the transferee account balance has not been maintained, funds continue to be transferred into the transferee account in operation 225 and the process continues. If the transferee account balance has been maintained as determined in either of operations 250 or 230, the customer is provided with a second reward in an operation 255. In an illustrative embodiment, the second reward is a monetary reward that is provided to the customer in the form of cash, a check, a pre-paid credit card, etc. The monetary reward can be provided to the customer in person or through the mail. Alternatively, the monetary reward may be automatically credited to the transferee account or a different financial account of the customer. In one embodiment, the monetary reward is $50. Alternatively, other values may be used such as $25, $75, $100, etc. In another alternative embodiment, the second reward may be in the form of free or discounted travel, free or discounted accommodations, free or discounted merchandise, etc.

In an operation 260, a tax form is generated for the customer. In an illustrative embodiment, the tax form is a 1099-INT form that identifies the second reward as income to the customer. The customer can use the tax form to help determine his/her taxes for the year. If the customer receives the first reward and the second reward within a single tax year, a single tax form identifying both the first and second rewards can be provided to the customer. In an illustrative embodiment, scheduled transfers continue to occur after the second reward is attained by the customer. In one embodiment, no additional rewards are available. Alternatively, the customer may be able to receive third and subsequent rewards by maintaining the transferee account balance at a specified threshold balance for a specified amount of time. The specified threshold balance and/or the specified amount of time may be the same as or different than the threshold balance and the predetermined amount of time requirements for receiving the second reward.

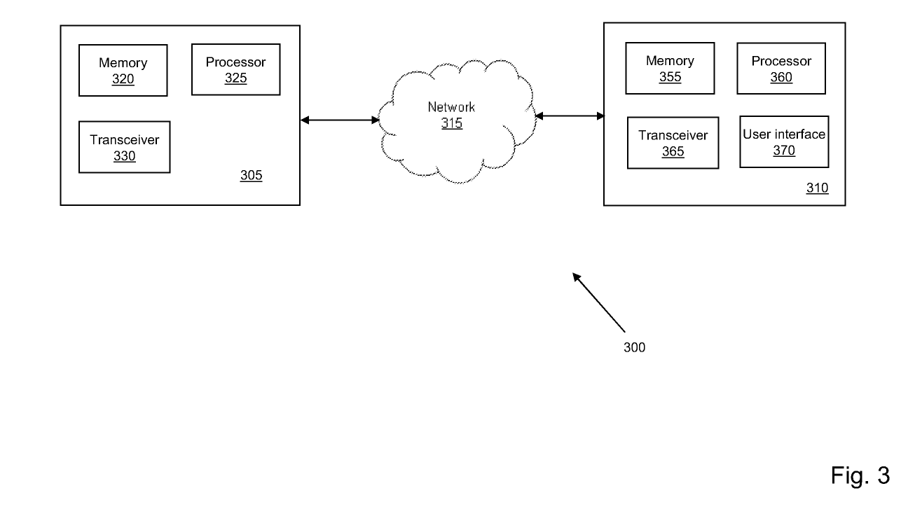

FIG. 3 is a block diagram illustrating a system 300 for implementing the savings and rewards program in accordance with an illustrative embodiment. System 300 includes a financial institution computing device 305 and a customer computing device 310. In an illustrative embodiment, financial institution computing device 305 can be used by a financial institution to provide a savings and rewards program as described herein. Customer computing device 310 can be utilized by a customer to enroll in the savings and rewards program, to make requests to skip scheduled transfers, to request an exemption, to update personal information, etc. Financial institution computing device 305 and customer computing device 310 can exchange information over a network 315. Network 315 can be a wide area network such as the Internet, a local area network, a wired or wireless telecommunications network, and/or any other data communication network known to those of skill in the art.

Financial institution computing device 305, which can be any type of computer, may be implemented as a server that provides customers with a website for enrolling in, accessing, and selecting options in the savings and rewards program. Financial computing device 305 may also be implemented as part of an automated teller machine (ATM), as part of a telephone banking system, etc. Financial institution computing device 305 includes a memory 320, a processor 325, and a transceiver 330. In alternative embodiments, financial institution computing device 305 may include additional components such as a user interface (i.e., a display, a keyboard, a touch screen, a touch pad, etc.), a magnetic card reader, a printer, etc. Each of the components of financial institution computing device 305 can be operatively coupled to one another according to any methods known to those of skill in the art.

Memory 320 can be used to store customer information, customer requests, financial account information, information regarding implementation of the savings and rewards program, and/or any other data pertaining to the savings and rewards program. Memory 320, which is a computer-readable medium, can also be used to store computer-readable instructions that, when executed, cause financial institution computing device 305 to perform any of the operations described herein for providing the savings and rewards program. Processor 325 can be configured to execute the computer-readable instructions. Processor 325 can also be configured to communicate with and/or control transceiver 330.

Transceiver 330 can be used to receive and/or transmit information through network 315. In an illustrative embodiment, transceiver 330 can communicate with a transceiver 365 of customer computing device 310. As an example, transceiver 330 can receive customer enrollment information, customer requests, account information, transfer option information, etc. from transceiver 365. Transceiver 330 can also transmit requests for information, customer options, etc. to transceiver 365. In an illustrative embodiment, transceiver 330 can be an internal or external modem. Transceiver 330 may also be any other receiving component and/or transmitting component known to those of skill in the art.

Customer computing device 310 can be a laptop computer, a desktop computer, a personal digital assistant, a cellular telephone, and/or any other type of computing device known to those of skill in the art. Customer computing device 310 includes a memory 355, a processor 360, transceiver 365, and a user interface 370. In alternative embodiments, customer computing device 310 can include fewer, additional, and/or different components. For example, customer computing device 310 may also include a battery, a printer, etc. In an illustrative embodiment, memory 355 can be configured to store a network browser capable of accessing a website provided by the financial institution. Processor 360 can be configured to execute any computer-readable instructions stored in memory 355. Processor 360 can also be configured to communicate with and/or control user interface 370, transceiver 365, and any other components of customer computing device 310.

Transceiver 365 can be used to receive and/or transmit information through network 315. In an illustrative embodiment, transceiver 365 can communicate with transceiver 330 of financial institution computing device 305. As an example, transceiver 365 can receive a request for information from transceiver 330, and transceiver 365 can transmit the requested information to transceiver 300. In an illustrative embodiment, transceiver 365 can be an internal modem. Transceiver 365 may also be any other receiving component and/or transmitting component known to those of skill in the art. User interface 370 can include a computer mouse, a keyboard, a display, a touch screen, a touch pad, and/or any other component that allows the customer to interact with customer computing device 310.

One or more flow diagrams have been used herein. The use of flow diagrams is not meant to be limiting with respect to the order of operations performed. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method for providing a savings and rewards program comprising:
receiving a selection of one or more transfer options for making automated funds transfers from a transferor account of a customer to a transferee account of the customer;
transferring a first amount of funds from the transferor account to the transferee account based at least in part on the selection of the one or more transfer options;
determining, based at least in part on a comparison of a balance of the transferee account to a first threshold balance, whether the customer is eligible for a first reward, wherein the determining is performed at least in part by a financial institution computing system;
providing the first reward to the customer if it is determined that the customer is eligible for the first reward;
determining whether the customer has maintained a second threshold balance in the transferee account for a predetermined time period; and
providing the customer with a second reward if it is determined that the customer has maintained the second threshold balance in the transferee account for the predetermined time period.

2. The method of claim 1, wherein the second threshold balance is the same as the first threshold balance.

3. The method of claim 1, wherein a start date from which the predetermined time period is measured comprises an initial date on which the balance of the transferee account is at least the first threshold balance.

4. The method of claim 1, further comprising resetting the predetermined time period if the balance of the transferee account drops below the second threshold balance.

5. The method of claim 4, further comprising making a determination of whether the balance of the transferee account is below the second threshold balance on only one day in each month, wherein the predetermined time period is reset only if the balance of the transferee account is below the second threshold balance on the one day.

6. The method of claim 1, further comprising receiving a request to activate a think twice feature for the transferee account.

7. The method of claim 6, further comprising:
receiving a request from the customer to remove a second amount of funds from the transferee account; and
providing the customer with a prompt if the think twice feature is activated, wherein the prompt reminds the customer that the transferee account is enrolled in the savings and rewards program and asks the customer to confirm that the customer wants to remove the second amount of funds from the transferee account.

8. The method of claim 7, wherein the prompt is provided to the customer through an automated teller machine.

9. The method of claim 7, wherein the prompt further informs the customer of a consequence if the customer removes the second amount of funds from the transferee account, wherein the consequence is with respect to at least one of the first reward or the second reward.

10. The method of claim 1, further comprising receiving a request from the customer to skip a scheduled transfer from the transferor account to the transferee account.

11. The method of claim 1, further comprising de-enrolling the customer from the savings and rewards program if a scheduled transfer of funds from the transferor account to the transferee account has not occurred within a deactivation time period.

12. The method of claim 1, further comprising determining the first threshold balance based at least in part on an initial balance in the transferee account at a time of enrollment into the savings and rewards program.

13. The method of claim 12, wherein the initial balance counts toward the first threshold balance only if the transferee account is a new account established at the time of enrollment into the savings and rewards program.

14. The method of claim 1, further comprising receiving a request for an exemption from the customer, wherein the predetermined time period is not reset in response to the balance of the transferee account dropping below the second threshold balance if a length of time that the balance was less than the second threshold balance does not exceed an exemption time period.

15. A financial institution computing system comprising:
a transceiver configured to receive a selection of one or more transfer options for making automated funds transfers from a transferor account of a customer to a transferee account of the customer; and
a processor operatively coupled to the transceiver and configured to
transfer a first amount of funds from the transferor account to the transferee account based at least in part on the selection of the one or more transfer options;
determine, based at least in part on a comparison of a balance of the transferee account to a first threshold balance, whether the customer is eligible for a first reward; and
determine whether the customer is eligible for a second reward based on whether the customer has maintained a second threshold balance in the transferee account for a predetermined time period.

16. The financial institution computing system of claim 15, wherein the transferor account comprises a rewards account that provides the customer with rewards for using a credit card or a debit card, and wherein the transferee account comprises a savings account.

17. The financial institution computing system of claim 16, wherein the rewards account has a minimum balance usage requirement, and wherein the first amount of funds transferred from the rewards account into the savings account is less than the minimum balance usage requirement.

18. A computer-readable medium having computer-readable instructions stored thereon, wherein, upon execution by a computing device, the computer-readable instructions cause the computing device to:
receive a selection of one or more transfer options for making automated funds transfers from a transferor account of a customer to a transferee account of the customer;
transfer a first amount of funds from the transferor account to the transferee account based at least in part on the selection of the one or more transfer options;
determine, based at least in part on a comparison of a balance of the transferee account to a first threshold balance, whether the customer is eligible for a first reward; and
determine whether the customer is eligible for a second reward based on whether the customer has maintained a second threshold balance in the transferee account for a predetermined time period.

19. The computer-readable medium of claim 18, wherein the computer-readable instructions further cause the computing device to generate a tax form for the customer, wherein the tax form identifies at least one of the first reward or the second reward.

20. The computer-readable medium of claim 18, wherein the computer-readable instructions further cause the computing device to provide the customer with a prompt if the customer attempts to remove a second amount of funds from the transferee account and a think twice feature is activated for the transferee account, and wherein the prompt reminds the customer that the transferee account is enrolled in a savings and rewards program and asks the customer to confirm that the customer wants to remove the second amount of funds from the transferee account.
